(19) United States
(12) Patent Application Publication
(10) Pub. No.: US 2026/0236256 A1
(43) Pub. Date: Aug. 13, 2026

(54) DETECTING DEVICE, DETECTING METHOD, AND DETECTING PROGRAM

(71) Applicant: NTT, Inc., Tokyo (JP)

(72) Inventors: Yo KANEMOTO, Musashino-shi, Tokyo (JP); Yuki YAMANAKA, Musashino-shi, Tokyo (JP)

(73) Assignee: NTT, Inc., Tokyo (JP)

(21) Appl. No.: 19/160,468

(22) PCT Filed: Mar. 3, 2023
(86) PCT No.: PCT/JP2023/008193

§ 371 Date: Aug. 28, 2025

(51) Int. Cl. G06F 8/75; G06F 8/41

(52) U.S. Cl. CPC G06F 8/751; G06F 8/433

(57) ABSTRACT

A detection device includes a memory and processing circuitry configured to divide a source code of software into a plurality of code blocks, calculate a hash value of each of the plurality of code blocks after division, generate a database in which the hash value of each of the plurality of code blocks calculated is associated with a value based on the hash value, and detect information regarding detection target software having a dependence relationship with the software on a basis of the database generated.

### TECHNICAL FIELD

The present invention relates to a detection device, a detection method, and a detection program.

### BACKGROUND ART

Software is used not only for IT systems but also for controlling machines that handle human life, such as automobiles and aircraft, and important infrastructure such as electricity and water supply infrastructure which is indispensable for daily life. In order to support a wide range of applications and requirements, functions required for software have increased, and complexity thereof has further increased. In a life cycle of developing software, various relationships occur and affect operations of the software. An explicit relationship and an implicit relationship exist in a relationship that affects operations of software.

The explicit relationship is a relationship in a state in which a relationship with software is clearly defined as information. Examples of the explicit relationship include a relationship in which an author is specified and a relationship in which other software or another library used in package information is specified. With the explicit relationship, in a case where a problem occurs in software which is used, it is possible to instantaneously ascertain whether there will be an impact on a user, increasing the likelihood that damage can be kept to a minimum.

On the other hand, the implicit relationship is a relationship in which a relationship with software is not explicitly defined. Examples of the implicit relationship include a relationship in which an author of the software is unknown, a relationship in which software or a library is used but the fact is not specified, and a relationship in which an author of software or the like is stated but cannot be identified by others. In a case where there is an implicit relationship, even if a problem occurs in software, a user does not know whether the user is affected. Thus, the user continues the relationship without noticing the existence of the security risk, which may delay identifying the cause of the problem in the software, resulting in damage spreading.

From the above description, it is important to reduce implicit relationships and make them explicit relationships in order to prevent the spread of damage. That is, in a society in which software is distributed transparently, it is important that original software is safe and reliable. For example, if new software is manufactured by incorporating open source software, in a case where a virus has an implicit relationship with the software even though there is the virus in the open source software, the manufactured software may adversely affect and spread the damage. On the other hand, in a case where a library is incorporated into software by using #import, it is clear which library the #import includes, and in a case where there is a problem in the library, a user can immediately notice the influence.

Among the above relationships that affect operations of software, particularly, a use relationship between software and a source code is referred to as a dependence relationship. For example, Bourne Again Shell (Bash), which is a standard terminal provided by GNU, uses Linux (registered trademark) C Library (libc) which is a standard library of the C language, cursors, and new curses (ncurses) which are libraries for operating screens. Therefore, Bash depends on libc and ncurses.

An explicit relationship and an implicit relationship also exist in the dependence relationship, the dependence relationship and the explicit relationship will be referred to as an explicit dependence relationship, and the dependence relationship and the implicit relationship will be referred to as an implicit dependence relationship. The explicit dependence relationship is a dependence relationship described in package information of software. Examples of the explicit dependence relationship include a relationship between items such as Depends and Build-Depends of a deb package and software. The implicit dependence relationship is a dependence relationship that does not explicitly appear. Examples of the implicit dependence relationship include a relationship in which index software and detection target software include code clones that match each other between these pieces of software, and the detection target software depends on the index software.

In a case where a relationship with software is an implicit dependence relationship, the software may be adversely affected by the original software without this being noticed, and the damage may be spread. For example, in a case where a code or a function of a library is directly copied to a source, a relationship with the library is not clear, and a user cannot notice a problem in another library.

In order to avoid the above-described problem, there is related art for detecting an implicit dependence relationship in advance. For example, there is a tool called CENTRIS that detects information regarding detection target software that has an implicit dependence relationship with software from detection candidate software including a code clone that matches a code clone of the software (see, for example, Patent Literature 1).

Hereinafter, an example of processing according to the related art such as CENTRIS will be described with reference to FIG. 8. FIG. 8 is a diagram for describing an example of processing according to the related art.

First, CENTRIS indexes a source code of index software. Specifically, as illustrated in FIG. 8, CENTRIS divides a source code of software into a plurality of code blocks (code block units) such as a code block F1, code blocks F2, . . . , and a code block Fn. CENTRIS may divide a source block into a plurality of functions instead of a plurality of code blocks. CENTRIS generates a locality sensitive hash (LSH) for each code block such as the code block F1, the code block F2, . . . , and the code block En. Subsequently, CENTRIS registers hash values such as a hash value LSH1, a hash value LSH2, . . . , and a hash value LSHn indicated by respective LSHs in a database in association with a name or a version of the software.

Next, CENTRIS divides a unique source code from detection candidate software. Specifically, as illustrated in FIG. 8, CENTRIS detects a portion corresponding to the unique source code of the detection candidate software by eliminating a portion having a dependence relationship of the nested structure that causes erroneous detection in the source code of the detection candidate software in advance. As a result, CENTRIS reduces the risk of a situation in which a source code having a dependence relationship of the nested structure with the detection candidate software is detected, the nested structure is not ascertained, a dependence relationship between the index software and the detection candidate software is not correctly determined, and an erroneous dependence relationship is detected.

Next, as illustrated in FIG. 8, similarly to the source code of the index software, CENTRIS divides the unique source code included in the detection candidate software into a plurality of code blocks such as a code block F1x, code block F2x, . . . , and a code block Fnx. Subsequently, CENTRIS generates LSHs for the respective code blocks such as the code block F1x, the code block F2x, and the code block Fnx.

Next, as illustrated in FIG. 8, CENTRIS compares hash values such as a hash value LSH1x, a hash value LSH2x, . . . , and a hash value LSHnx indicated by the respective LSHs with the hash values such as the hash value LSH1, the hash value LSH2, . . . , and the hash value LSHn stored in the database. If these hash values match, CENTRIS determines that the code blocks corresponding to these hash values are similar to each other. When the number of similar code blocks are equal to or more than a predetermined ratio Θ, CENTRIS detects the detection candidate software as detection target software having an implicit dependence relationship with the index software.

### CITATION LIST

### Non Patent Literature

Non Patent Literature 1: Seunghoon Woo, Sunghan Park, Seulbae Kim, Heejo Lee, and Hakjoo Oh. CENTRIS: A Precise and Scalable Approach for Identifying Modified Open-Source Software Reuse. In ICSE, 2021

### SUMMARY OF INVENTION

### Technical Problem

However, in the related art for detecting an implicit dependence relationship such as CENTRIS described above, in some cases, detection omission of detection target software having an implicit dependence relationship with software cannot be reduced. Hereinafter, an example of a problem of the related art will be described with reference to FIG. 9. FIG. 9 is a diagram for describing an example of a problem of the related art.

For example, as illustrated in the drawing of the detection omission in FIG. 9, in the related art, only whether the hash value LSH1 and the hash value LSH1X match each other is simply determined, and in a case where the hash value LSH1 and the hash value LSH1X match each other, it is determined that the code blocks corresponding to these hash values are similar to each other. Here, even in a case where the source code is slightly modified, the hash value LSH1X corresponding to the code block is another hash value LSH1X′. Thus, in the related art, it cannot be determined that the code block corresponding to the hash value LSH1X′ that does not completely match the hash value LSH1 is similar to the code block corresponding to the hash value LSH1. That is, in the related art, in a case where the source code is modified, it is not possible to detect that the code blocks are similar to each other, which may lead to detection omission of detection target software having an implicit dependence relationship with the software.

### Solution to Problem

In order to solve the above-described problems and achieve the object, a detection device includes a division unit that divides a source code of software into a plurality of code blocks; a calculation unit that calculates a hash value of each of the plurality of code blocks after division in the division unit; a generation unit that generates a database in which the hash value of each of the plurality of code blocks calculated by the calculation unit is associated with a value based on the hash value; and a detection unit that detects information regarding detection target software having a dependence relationship with the software on a basis of the database generated by the generation unit.

### Advantageous Effects of Invention

According to the present invention, it is possible to reduce detection omission of detection target software having an implicit dependence relationship with software.

### BRIEF DESCRIPTION OF DRAWINGS

FIG. 1 is a diagram illustrating an example of a configuration of a detection system.

FIG. 2 is a diagram for describing an outline of a server.

FIG. 3 is a diagram for describing an outline of the server.

FIG. 4 is a diagram illustrating an example of a database.

FIG. 5 is a flowchart illustrating an example of a flow of a database generation process.

FIG. 6 is a flowchart illustrating an example of a flow of a detection process for a detection target.

FIG. 7 is a diagram illustrating an example of a configuration of a computer that executes a detection program.

FIG. 8 is a diagram for describing an example of processing according to the related art.

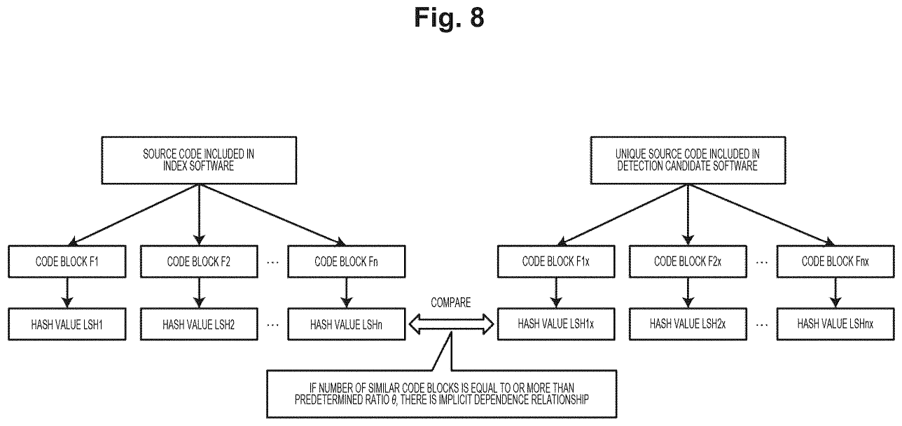

FIG. 9 is a diagram for describing an example of a problem of the related art.

### DESCRIPTION OF EMBODIMENTS

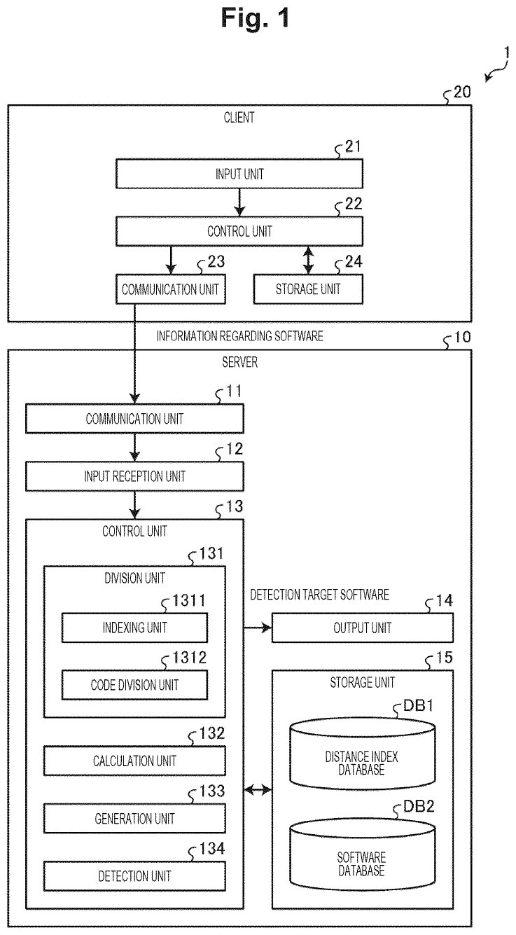

Hereinafter, embodiments of the present invention will be described in detail with reference to the drawings. In the following embodiments, the same elements are denoted by the same reference numerals, and redundant description may be omitted.

[Example of configuration of detection system] An example of a configuration of a detection system 1 according to the present embodiment will be described with reference to FIG. 1. FIG. 1 is a diagram illustrating an example of a configuration of the detection system. The detection system 1 divides a source code of software into a plurality of code blocks, calculates a hash value of each of the plurality of code blocks, generates a database in which the hash value of each of the plurality of code blocks is associated with a value based on the hash value, and detects, on the basis of the database, information regarding detection target software having a dependence relationship with the software.

The dependence relationship is a use relationship between software and a source code among relationships that affect operations of the software. Examples of the dependence relationship include an implicit dependence relationship in which index software and detection target software include code clones that match each other between these pieces of software, and the detection target software depends on the index software. The information regarding the detection target software indicates a value similar to a hash value of each of the plurality of code blocks in the source code of the software or the detection target software having a similar value.

In the example illustrated in FIG. 1, the detection system 1 includes a client 20 and a server 10 functioning as the detection device, but instead of these, each member of the following server 10 may be provided, and only the client 20 functioning as the detection device may be included.

[Example of configuration of client] The client 20 transmits information regarding input software to the server 10. Examples of the client 20 include a terminal. In the example illustrated in FIG. 1, the client 20 includes an input unit 21, a control unit 22, a communication unit 23, and a storage unit 24. The information regarding the software is information regarding various kinds of software such as index software, detection target software detected by the server 10, and detection candidate software serving as a candidate for the detection target. The information regarding the software is also information regarding a software group registered in a software database DB2 by the server 10.

The input unit 21 receives information regarding software from a user. Examples of the input unit 21 include a keyboard and a touch panel of a terminal.

The control unit 22 controls the entire client 20. For example, the control unit 22 includes one or more processors having an internal memory in which a program. defining various processing procedures and control data are stored. The processor executes each process by using a program or an internal memory. Examples of the control unit 22 include electronic circuits such as a central processing unit (CPU), a micro processing unit (MPU), and a graphics processing unit (GPU), and integrated circuits such as an application specific integrated circuit (ASIC) and a field programmable gate array (FPGA).

The communication unit 23 transmits the information regarding the software to the server 10. For example, the communication unit 23 transmits the information regarding the software to a communication unit 11 of the server 10 via a telecommunication line such as a local area network (LAN) or the Internet. Examples of the communication unit 23 include a network interface card (NIC).

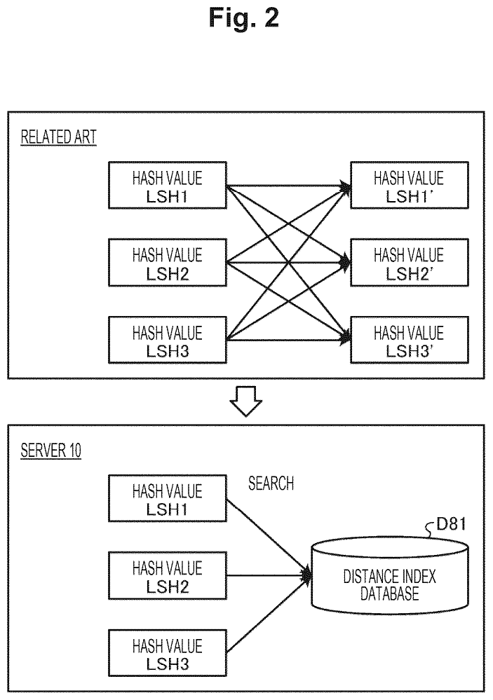

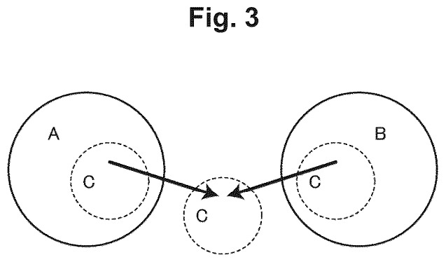

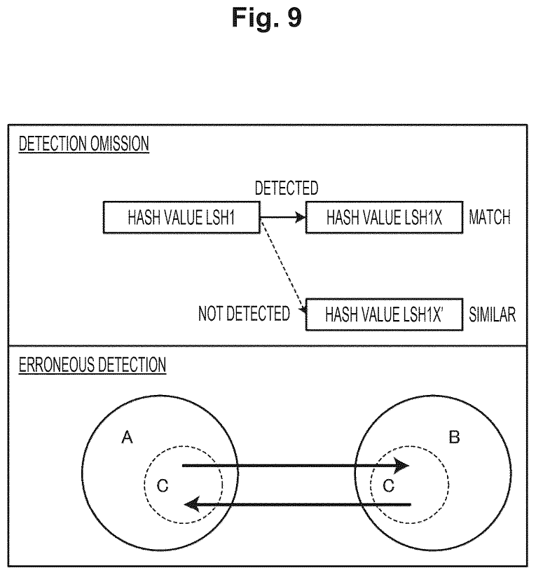

The storage unit 24 stores various types of information such as information regarding software input to the input unit 21. Examples of the storage unit 24 include storage devices such as a hard disk drive (HDD), a solid state drive (SSD), and an optical disc, and semiconductor memories capable of rewriting data, such as a random access memory (RAM), a flash memory, and a non-volatile static random access memory (NVSRAM). The storage unit 24 stores an operating system (OS) and various programs executed by the client 20.

[Example of configuration of server] The server 10 functions as a detection device that divides a source code of software into a plurality of code blocks, calculates a hash value of each of the plurality of code blocks, generates a database in which a hash value of each of the plurality of code blocks is associated with a value based on the hash value, and detects, on the basis of the database, information regarding detection target software having a dependence relationship with the software. Hereinafter, problems of the related art will be described with reference to FIGS. 2 and 9, and then an outline of the server 10 will be described with reference to FIGS. 2 and 3. FIGS. 2 and 3 are diagrams for describing an outline of the detection device.

As illustrated in the drawing of the detection omission in FIG. 9, in the related art, it is simply determined whether or not the hash value LSH1 and the hash value LSH1X match each other, and in a case where the hash value LSH1 and the hash value LSH1X match each other, it is determined that code blocks corresponding to these hash values are similar to each other. Thus, in the related art, in a case where the source code is modified, it cannot be detected that the code blocks are similar to each other, which may lead to detection omission of detection target software having an implicit dependence relationship with the software.

As illustrated in FIG. 2, in a case where the hash value LSH includes the hash value LSH1, the hash value LSH2, and the hash value LSH3, and the hash value LSH′ includes the hash value LSH1′, the hash value LSH2′, and the hash value LSH3′, in the related art, these hash values are compared with each other in a round-robin. For example, in the related art, it is compared whether or not the hash value LSH1, the hash value LSH2, and the hash value LSH3 match the hash value LSH′, the hash value LSH2′, and the hash value LSH3′, respectively. Thus, in the related art, in some cases, detection target software having a code block similar to the code block of the source code cannot be efficiently retrieved.

In the related art, in some cases, detection target software is erroneously detected. For example, in the example illustrated in the drawing of erroneous detection in FIG. 9, a relationship between software A and software C and a relationship between the software B and the software C are dependence relationships of N: 1 such that the software A includes the software C and the software B includes the software C. In the example illustrated in FIG. 9, the software C is not registered in the database. In this case, in the related art, it may be erroneously detected that the software A depends on the software B or the software B depends on the software A. As described above, in the related art, when a plurality of pieces of software includes the same software or code clone such as a source code, in some cases, it is erroneously detected that there is an implicit dependence relationship with each other.

In contrast, an algorithm for detecting information regarding detection target software having a dependence relationship with software by using a database in which a hash value of each of a plurality of code blocks and a value based on the hash value are associated with each other is added to the server 10 compared with the related art. As a result, the server 10 solves the problem of reducing the detection omission, and can detect the detection target software having an implicit dependence relationship with index software with high accuracy. An algorithm for detecting detection candidate software as detection target software in a case where a common keyword is not included in a path of a code clone may be further added to the server 10 compared with the related art. Since the two algorithms are added to the server 10, the server 10 can further reduce erroneous detection.

For example, for the problem of detection omission, as illustrated in FIG. 2, the server 10 searches for detection target software by using a distance index database DB1 generated in advance for a hash value of each of a plurality of code blocks. The distance index database DB1 is a database in which a hash value of each of a plurality of code blocks in software is associated with a value based on the hash value.

Here, a value based on a hash value may be a value or the like obtained by converting the hash value by using a predetermined algorithm, and examples thereof include a value configured by a combination of parts of a code string represented as the hash value. For this reason, the distance index database DB1 is, for example, a database in which a hash value of each of a plurality of code blocks in index software is associated with each value configured by a combination of parts of a code string represented as the hash value.

By using the distance index database DB1, the server 10 searches for a value in which a Hamming distance between each of the hash value LSH1, the hash value LSH2, and the hash value LSH3 and each value configured by a combination of parts of a code string represented as the hash value is a predetermined value or less. The Hamming distance is a distance representing the number of locations at which codes at the same position as the code string represented as the hash value are different. As a result, the server 10 can greatly reduce the number of Hamming distance calculation processes and pieces of detection candidate software, and can efficiently search for a value similar to a hash value of a code block of index software. That is, the server 10 can search for a code block similar to the code block of the index software. As a result, the server 10 can efficiently search for detection target software having a code block similar to a code block of a source code.

For erroneous detection, as illustrated in FIG. 3, the server 10 determines whether a common keyword is included in a path such as a directory name or a file name of the software C, which is a code clone matching between the software A and the detection candidate software B. Through this determination, the server 10 determines whether the detection candidate software B is detected as detection target software. That is, the server 10 determines whether the detection candidate software B has a dependence relationship with the software A or a dependence relationship with other software.

More specifically, the server 10 generates a keyword from a directory name or a file name of the software C that is a code clone, and determines whether a common keyword is included in the software A that is a code clone source and the software B that is a code clone destination. In a case where a common keyword is included in the software A and the software B, the server 10 excludes the software B from candidates for the dependence relationship since there is no dependence relationship between the software A and the software B. In this case, for example, the server 10 estimates that the common keyword is a path name of the software C in another dependence relationship (new dependence destination) that is not included in the software A and the software B registered in the software database DB2.

Next, a configuration of the server 10 will be described with reference to FIG. 1. In the example illustrated in FIG. 1, the server 10 includes a communication unit 11, an input reception unit 12, a control unit 13, an output unit 14, and a storage unit 15.

The communication unit 11 receives information regarding software from the client 20. For example, the communication unit 11 receives information regarding software from the client 20 via a telecommunication line such as a LAN or the Internet. Examples of the communication unit 11 include an NIC.

The input reception unit 12 receives input of information regarding software input to the input unit 21 of the client 20 via the communication unit 11, the communication unit 23 of the client 20, and the like.

The control unit 13 controls the entire server 10. For example, the control unit 13 includes one or more processors having a program defining various processing procedures and an internal memory storing control data, and the processor executes each process by using the program and the internal memory. Examples of the control unit 13 include electronic circuits such as a CPU, an MPU, and a GPU, and integrated circuits such as an ASIC and an FPGA. In the example illustrated in FIG. 1, the control unit 13 includes a division unit 131, a calculation unit 132, a generation unit 133, and a detection unit 134.

The division unit 131 divides a source code of software. In the example illustrated in FIG. 1, the division unit 131 includes an indexing unit 1311 and a code division unit 1312.

The indexing unit 1311 divides a source code of software into a plurality of code blocks. That is, the indexing unit 1311 divides the source code of the software into code block units. A division target of a source code is not particularly limited as long as a source code of software is indexed. For example, the indexing unit 1311 may divide the source code of the software into a plurality of functions instead of a plurality of code blocks, that is, in units of functions.

The code division unit 1312 divides a unique source code from software such as detection candidate software. For example, the code division unit 1312 detects a portion corresponding to a unique source code of the detection candidate software by eliminating a portion having a dependence relationship of the nested structure that causes erroneous detection in the source code of the detection candidate software in advance. As a result, the code division unit 1312 reduces a case where a source code having a dependence relationship of the nested structure with a detection candidate software is detected, the nested structure is not ascertained, a dependence relationship between software and the detection candidate software is not correctly determined, and an erroneous dependence relationship is detected.

The calculation unit 132 calculates a hash value of each of the plurality of code blocks after division in the division unit 131. For example, the calculation unit 132 generates a locality sensitive hash (LSH) for each of the plurality of code blocks and calculates a hash value of each LSH.

The generation unit 133 generates a database in which the hash value of each of the plurality of code blocks calculated by the calculation unit 132 is associated with a value based on the hash value. For example, the generation unit 133 generates the distance index database DB1 in which a hash value of each of the plurality of code blocks is associated with a value configured by a combination of parts of a code string represented as the hash value. The generation unit 133 may further generate the software database DB2 in which information regarding index software and a software group such as detection target software detected by the server 10 and detection candidate software serving as a candidate for the detection target software is registered.

Hereinafter, an example of generation of the distance index database DB1 by the generation unit 133 will be described by using a mathematical expression. For example, the generation unit 133 generates the distance index database DB1 through the following processes (1) to (4).
(1) The generation unit 133 divides the hash value H registered in the distance index database DB1 into n (d+a) values and sets the values as the hash value H=(h_1, . . . , h_n). Here, d is a value of a Hamming distance desired by a user, and examples thereof include a threshold value in a range similar to the hash value H. In addition, a is a constant.
(2) The generation unit 133 selects a values k from the hash value H=(h_1, . . . , h_n) to generate the values k=(h′_1, . . . , h′_a), and adds the hash value H to an associative array list M[k][i][j] of the distance index database DB1. k is a value based on a hash value, and is specifically a value configured by a combination of parts of a code string represented as the hash value H.

i is a value indicating a corresponding position of a code on the left side of two codes generated on the basis of the hash value H when counted in order from the left with the left end being the zeroth position in a code string represented as the hash value H. j is a value indicating a corresponding position of a code on the right side of two codes generated on the basis of the hash value H when counted in order from the left with the left end being the zeroth position in a code string represented as the hash value H. For example, if the hash value H=34fe and k=34, i corresponding to 3 corresponds to the zeroth position at the left end of the hash value H and thus i=0, and j corresponding to 4 is adjacent to the right of the left end of the hash value H and thus j=1.
(3) The generation unit 133 repeats the process of (2) for the C(n, a) values k.
(4) The generation unit 133 repeats the above-described processes (1) to (3) by the number of hash values registered in the distance index database DB1.

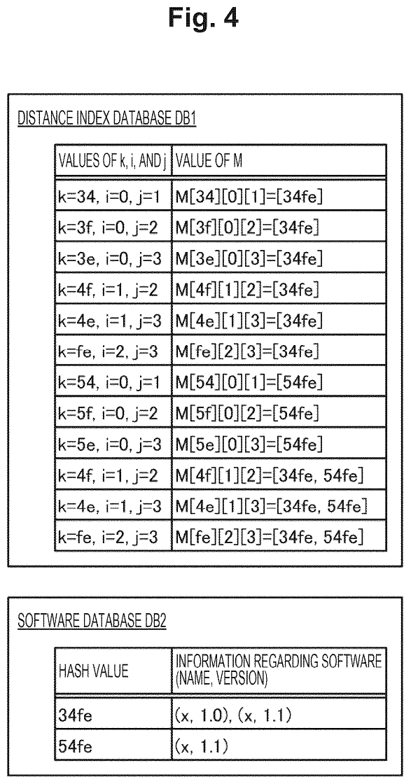

Hereinafter, an example of generation of the distance index database DB1 by the generation unit 133 will be described with reference to FIG. 4. FIG. 4 is a diagram illustrating an example of a database. In the example illustrated in the drawing of the software database DB2 in FIG. 4, there are two code blocks in software X, and hash values of these code blocks are 34fe and 54fe, respectively. In this case, the generation unit 133 registers each of the hash value 34fe and the hash value 54fe in the distance index database DB1 as the list M[k][i][j].

First, the generation unit 133 registers the hash value H=34fe through the following processes (I) to (III).
(I) The generation unit 133 divides the hash value H into four (n=d+a=2+2) values, and sets the values as the hash value H=(3, 4, f, e). Here, d is 2, and a is 2.
(II) The generation unit 133 selects two (a=2) values from the hash value H=(3, 4, f, e) to generate a value k, and adds 34fe to the list M[k][i][j].
(III) The generation unit 133 repeats the above process (II) for C (4, 2) values k=(34, 3f, 3e, 4f, 4e, fe).

Next, the generation unit 133 registers the hash value H=54fe through the following processes (i) to (iii).
(i) The generation unit 133 divides the hash value H into four (n=d+a=2+2) values, and sets the values as the hash value H=(5, 4, f, e). Here, d is 2, and a is 2.
(ii) The generation unit 133 selects two (a=2) values from the hash value H=(5, 4, f, e) to generate a value k, and adds 54fe to the list M[k][i][j].
(iii) The generation unit 133 repeats the above process (ii) for C (4, 2) values k=(54, 5f, 5e, 4f, 4e, fe).

The generation unit 133 generates the distance index database DB1 illustrated in the drawing of the distance index database DB1 in FIG. 4 by registering the hash value 34fe and the hash value 54fe of the two code blocks of the software X as described above.

The generation unit 133 may generate the software database DB2 in which information regarding software is associated with a hash value of the software. For example, as illustrated in FIG. 4, the generation unit 133 generates the software database DB2 in which the name x of software, the version 1.0 of the software, and the hash value 34fe are associated with each other.

The detection unit 134 detects information regarding detection target software having a dependence relationship with the software on the basis of the database generated by the generation unit 133. The detection unit 134 may detect the information regarding the detection target software further on the basis of a Hamming distance between the hash value of each of the plurality of code blocks and each value configured by a combination of parts of a code string represented as the hash value. For example, the detection unit 134 determines whether or not a Hamming distance between a hash value of each of a plurality of code blocks in index software stored in the distance index database DB1 and each value configured by a combination of parts of a code string represented as the hash value is equal to or less than a predetermined value. The detection unit 134 detects a value at which the Hamming distance is equal to or less than a predetermined value as the information regarding the detection target software.

The detection unit 134 may detect the information regarding the detection target software on the basis of the number of values at which the Hamming distance for the hash value of each of the plurality of code blocks is equal to or less than a predetermined value. For example, the detection unit 134 detects, as detection target software, detection candidate software in which the number of values at which the Hamming distance for the hash value of each of the plurality of code blocks in the index software is equal to or smaller than a predetermined value is equal to or more than a predetermined number. That is, the detection unit 134 detects, as detection target software, detection candidate software including a predetermined ratio or more of code blocks similar to the plurality of code blocks in the index software.

The detection unit 134 may further use the software database DB2 to detect information regarding detection target software. For example, the detection unit 134 uses the name and the hash value of the index software stored in the software database DB2, the name and the hash value of the detection candidate software, and the distance index database DB1 to search for a value similar to the hash value of each of the plurality of code blocks of the index software.

Hereinafter, an example of search by the detection unit 134 will be described using a mathematical expression. Hereinafter, the detection unit 134 searches whether or not a value at which a Hamming distance for a hash value Q is equal to or less than d exists in the distance index database DB1. In this case, the detection unit 134 searches the distance index database DB1 through the following processes (A) to (C).
(A) The detection unit 134 divides the hash value Q into n=(d+a) values, and sets the values as the hash value Q=(q_1, . . . , q_n).
(B) The detection unit 134 selects a values k from the hash value Q=(q_1, . . . , q_n) to generate the values k=(q′_1, . . . , q′_a). Subsequently, the detection unit 134 compares all the values included in the list M[k][i][j] of the distance index database DB1 with the hash value Q. In a case where the Hamming distance for the hash value Q is equal to or less than d, the detection unit 134 detects the corresponding value as a value corresponding to each of the plurality of code blocks of the detection target software, and stores the value in the storage unit 15 as a result list.
(C) The detection unit 134 repeats the above process (B) for C(n, a) values k, and causes the output unit 14 to output the result list.

Hereinafter, an example of search using the detection unit 134 will be described with reference to FIG. 4. Here, a case where there is one code block in software Y and the hash value Q of the code block is a hash value Q=54ef will be described. A case where the detection unit 134 searches whether or not a value equal to or less than the Hamming distance d=2 for the hash value Q exists in the distance index database DB1 will be described. In this case, the detection unit 134 searches the distance index database DB1 through the following processes (a) to (c).
(a) The detection unit 134 divides the hash value Q into four (n=d+a=2+2) values, and sets the values as the hash value Q=(5, 4, e, f).
(b) The detection unit 134 selects two values k from the hash value Q=(5, 4, e, f) to generate the values k. Subsequently, the detection unit 134 compares the distances between all the values included in the list M[k][i][j] of the distance index database DB1 and the hash value Q.
(c) The detection unit 134 repeats the above process (b) for C(n, a) values k=(54, 5e, 5f, 4e, 4f, ef) and causes the output unit 14 to output a result list.

For example, as a result of repeating the above process (b) in the above (c), if a value of the list M[k][i][j] exists only in the case of k=54, i=0, and j=1, the detection unit 134 compares all the values [54fe] included in the list M [54][0][1] with the hash value Q. In a case where the Hamming distance d for these hash values is ham(54ef, 54fe)=2, since the Hamming distance d is 2 or less, the detection unit 134 stores the value [54fe] in the storage unit 15 as a result list and causes the output unit 14 to output the result list.

In the example illustrated in FIG. 4, since two hash values are registered in the software database DB2, it is necessary to perform the comparison twice when the hash values are compared in a round-robin as in the related art. In contrast, by utilizing the distance index database DB1, the detection unit 134 can search for a value of the Hamming distance d=2 or less by comparing the hash values once.

In a case where a common keyword is not included in a path of a code clone that matches between software and detection candidate software, the detection unit 134 may detect the detection candidate software as detection target software. In a case where a common keyword is not included in a directory name or a file name of a code clone, the detection unit 134 may detect the detection candidate software as detection target software.

In a case where a common keyword is included in a path of the code clone, the detection unit 134 may exclude the detection candidate software from candidates for a dependence relationship. In a case where the common keyword is included in the path of the code clone and the common keyword is not included in the software name of the software and the software name of the detection candidate software, the detection unit 134 excludes the detection candidate software from candidates for a dependence relationship. For example, in this case, the detection unit 134 determines that the detection candidate software has a dependence relationship with other software, and excludes the detection candidate software from candidates having a dependence relationship with the software.

Hereinafter, an example of detection using the detection unit 134 will be described by using a mathematical expression. Hereinafter, the detection unit 134 performs the following processes (A) to (Γ) on each of pieces of detection candidate software Y, and thus determines whether or not a dependence relationship is generated between software Z different from the index software X and the detection candidate software Y. In a case where it is determined that a dependence relationship is generated between other software Z and the detection candidate software Y, the detection unit 134 excludes the detection candidate software Y from candidates having a dependence relationship with the index software X.
(A) Generation of keyword

The detection unit 134 combines both a path S=(s1, s2, . . . ) of the code clone of the index software X and a path D=(d1, d2, . . . ) of the code clone of the detection candidate software Y to generate a path P=(p1, p2, . . . ). The detection unit 134 divides each element p_i of the path P by using a path delimiter, and normalizes code strings (for example, text) of directory names and file names after division. The detection unit 134 stores keywords K=(k1, k2, . . . ) of the code strings of the directory names and file names after division.
(B) Extraction of common keyword

For each k (k1, k2, . . . ) that is a code string of the keyword K, the detection unit 134 determines whether k is included in each of the path S and the path D. In this case, the detection unit 134 calculates the number of appearances of each k for both of the path S and the path D as C_s=(cs_1, . . . , cs_k) and C_d=(cd_1, . . . , cd_k). The detection unit 134 divides the calculated values of C_s=(cs_1, cs_k) and C_d=(cd_1, . . . , cd_k) by the number of code strings of the paths S and D. Consequently, the detection unit 134 calculates an appearance probability of each k for the path S as H_s=(hs_1, . . . , hs_k)=(cs_1/|S|, . . . , cs_k/|S|). The detection unit 134 calculates an appearance probability of each k for the path D as H_d=(hd_1, . . . , hd_k)=(cd_1/|D|, . . . , cd_k/|D|). The detection unit 134 extracts a common keyword K′=(k′1, k′2, . . . ) satisfying {h|hs_i>T and hd_j>T}. Here, T is a threshold value for the appearance probability of each k.
(Γ) Determination of dependence relationship

In a case where the common keyword K′ is not extracted, the detection unit 134 may detect the detection candidate software Y as detection target software having a dependence relationship with the index software X. In a case where the common keyword K′ is extracted, the detection unit 134 determines whether or not each k′ (k′1, k′2, . . . ) that is a code string of the common keyword K′ is included in the software name of the index software X and the software name of the detection candidate software Y.

When each k′ is not included in the software name of the index software X and the software name of the detection candidate software Y, the detection unit 134 determines that there is no relationship of the index software X->the detection candidate software Y in which the detection candidate software Y depends on the index software X. The detection unit 134 determines that there is a relationship of the index software X->other software Z in which the index software X depends on other software Z. The detection unit 134 determines that there is a relationship of the detection candidate software Y->other software Z in which the detection candidate software Y depends on the software Z different from the index software X. The detection unit 134 excludes the detection candidate software Y from candidates for a dependence relationship.

The detection unit 134 determines a dependence relationship of all the pieces of detection candidate software Y, and causes the output unit 14 to output, as detection target software, the detection candidate software Y remaining as having the dependence relationship with the index software X of the among the pieces of detection candidate software Y.

Next, another example of detection by the detection unit 134 will be described using a mathematical expression. Hereinafter, the detection unit 134 performs the following processes (α) to (γ) on each piece of the detection candidate software Y to determine whether or not a dependence relationship is generated between software different from the index software X and the detection candidate software Y. For example, in a case where it is determined that there is a dependence relationship of the index software X->the detection candidate software Y in the index software X and the detection candidate software Y through the processes (A) to (Γ) described above, the detection unit 134 again determines whether there is a dependence relationship.
(α) Generation of keyword

The detection unit 134 combines both the path S=(/sdk/bzip/compress.c,/sdk/bzip/decompress.c) of the code clone of the index software X and the path D=(/src/bzip2/compress.c,/src/bzip2/decompress.c) of the code clone of the detection candidate software Y to generate a path P=S+D. Specifically, the detection unit 134 generates the path P=(/sdk/bzip/bzlib.c,/sdk/bzip/decompress.c,/src/bzip2/bzli b.c,/src/bzip2/decompress.c). The detection unit 134 divides each element of the path P by using a path delimiter, and obtains a set of code strings of directory names and file names after division from which extensions are removed. The detection unit 134 normalizes a result obtained by removing a predefined excluded keyword from this set, and stores the normalized result as a keyword K=(sdk, bzip, bzlib, decompress, src, bzip2).
(β) Extraction of Common Keyword

The detection unit 134 determines, for each k (k1, k2, . . . ) that is a code string of the keyword K, whether each k is included in the path S and the path D. In this case, the detection unit 134 calculates the number of appearances of each k for the path S and the path D as Cs=(2, 2, 1, 1, 0, 0) and Cd=(0, 2, 1, 1, 2, 2). The detection unit 134 divides the calculated values of Cs=(2, 2, 1, 1, 0, 0) and Cd=(0, 2, 1, 1, 2, 2) by the number of code strings of each of the paths S and D. Consequently, the detection unit 134 calculates an appearance probability of each k for the path S as HS=(2/2, 2/2, 1/2, 1/2, 0/2, 0/2). The detection unit 134 calculates an appearance probability of each k for the path D as HD=(0/2, 2/2, 1/2; 1/2, 2/2, 2/2). In a case where a threshold value T for the appearance probability of each k is T=0.5, the detection unit 134 extracts a common keyword K′=(bzip) satisfying {h|hs_i>T and hd_j>T}.
(γ) Determination of dependence relationship

In a case where the common keyword K′ is not extracted, the detection unit 134 may detect the detection candidate software Y as detection target software having a dependence relationship with the index software X. In a case where the common keyword K′ is extracted, the detection unit 134 determines whether or not each k′ (k′1, k′2, . . . ) that is a code string of the common keyword K′ is included in the software name of the index software X and the software name of the detection candidate software Y.

In a case where each k′ is not included in the software name of the index software X and the software name of the detection candidate software Y, the detection unit 134 determines that the common keyword K′=(bzip) is not included in the index software X and the detection candidate software Y. That is, the detection unit 134 determines that there is no relationship of the index software X->the detection candidate software Y in which the detection candidate software Y depends on the index software X.

The detection unit 134 determines that there is a relationship of the index software X->other software bzip in which the index software X depends on other software bzip. The detection unit 134 determines that there is a relationship of the detection candidate software Y->other software bzip in which the detection candidate software Y depends on the software bzip different from the index software X. The detection unit 134 excludes the detection candidate software Y from candidates for a dependence relationship. As a result, the detection unit 134 can reduce erroneous detection such as the index software X->the detection candidate software Y.

In a case where the number of values at which a Hamming distance for a hash value of each of a plurality of code blocks is equal to or less than a predetermined value is equal to or larger than a predetermined number, and the common keyword is not included in the path of the code clone that matches between the software and the detection candidate software, the detection unit 134 may detect the detection candidate software as detection target software. For example, the detection unit 134 determines that the detection candidate software that includes a plurality of code blocks similar to the plurality of code blocks in the index software at a predetermined ratio or more and does not include the common keyword in the path of the code clone has a dependence relationship with the index software. The detection unit 134 detects the detection candidate software as detection target software.

The output unit 14 outputs data of a detection result from the detection unit 134. As an example, in a case where a value similar to the hash value of the code block of the index software is detected by the detection unit 134, the output unit 14 outputs a result list indicating a result of the similar value. As another example, the output unit 14 outputs information regarding the detection target software having a dependence relationship with the index software in the detection unit 134.

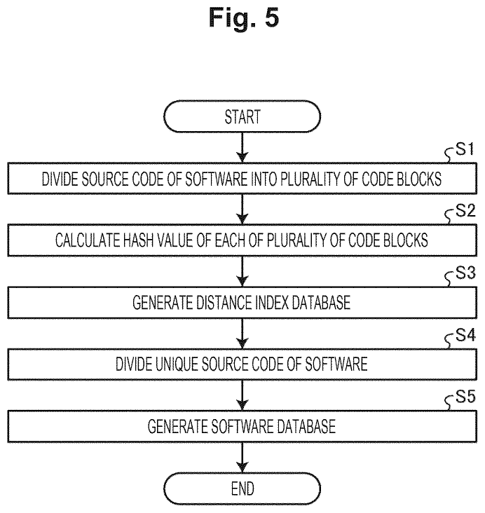

The storage unit 15 stores various types of information of the distance index database DB1 and the software database DB2 generated by the generation unit 133, and the detection results (for example, a result list in which results of similar values are shown) from the detection unit 134. Examples of the storage unit 15 include storage devices such as an HDD, an SSD, and an optical disc, and semiconductor memories capable of rewriting data, such as a RAM, a flash memory, and an NVSRAM. The storage unit 15 stores an OS and various programs executed by the server 10.

[Example of Flow of Processing in Server] Hereinafter, a flow of processing in the server 10 functioning as the detection device will be described. First, a flow of a database generation process in processing performed by the server 10 will be described with reference to FIG. 5. FIG. 5 is a flowchart illustrating an example of a flow of database generation process.

As illustrated in FIG. 5, the indexing unit 1311 divides a source code of software into a plurality of code blocks (step S1).

The calculation unit 132 calculates a hash value of each of the plurality of code blocks after division in the indexing unit 1311 (step S2).

The generation unit 133 generates the distance index database DB1 in which the hash value of each of the plurality of code blocks calculated by the calculation unit 132 is associated with a value based on the hash value (step S3).

The code division unit 1312 divides a unique source code of the software from the source code of the software (step S4).

The generation unit 133 generates the software database DB2 on the basis of the unique source code divided by the code division unit 1312 (step S5). For example, the generation unit 133 generates the software database DB2 in which a name and a version of the software having the unique source code are associated with the hash value of the software.

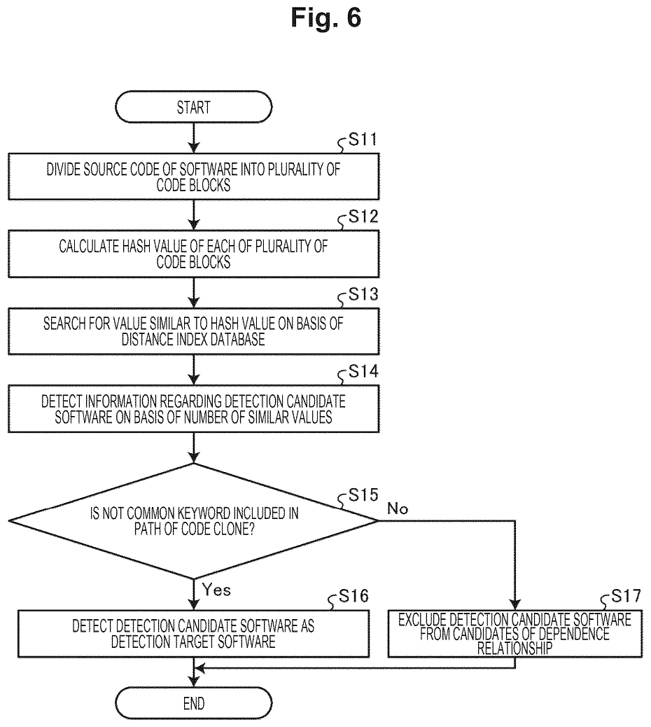

Next, a flow of a detection process for detection target software having a dependence relationship with the software in the server 10 will be described with reference to FIG. 6. FIG. 6 is a flowchart illustrating an example of a flow of a detection process for a detection target.

As illustrated in FIG. 6, the indexing unit 1311 divides a source code of software into a plurality of code blocks (step S11).

The calculation unit 132 calculates a hash value of each of the plurality of code blocks after division in the indexing unit 1311 (step S12).

The detection unit 134 searches for a value similar to the hash value of each of the plurality of code blocks calculated by the calculation unit 132 on the basis of the distance index database DB1 generated by the generation unit 133 (step S13). For example, the detection unit 134 searches for a value at which the Hamming distance for the hash value of each of the plurality of code blocks is equal to or less than a predetermined value by using the distance index database DB1.

The detection unit 134 detects information regarding detection candidate software on the basis of the number of values similar to the hash value of each of the plurality of code blocks calculated by the calculation unit 132 (step S14). For example, the detection unit 134 detects software in which the number of values at which the Hamming distance for the hash value of each of the plurality of code blocks is equal to or less than a predetermined value is equal to or larger than a predetermined number as detection candidate software.

The detection unit 134 determines whether a common keyword is included in a path of a code clone that matches between the software and the detection candidate software. If it is determined that the common keyword is not included in the path of the code clone (Yes in step S15), the detection unit 134 detects the detection candidate software as detection target software having a dependence relationship with the index software (step S16).

If it is determined that the common keyword is included in the path of the code clone (No in step S15), the detection unit 134 excludes the detection candidate software from candidates for a dependence relationship (step S17). For example, if it is determined that the common keyword is included in the path of the code clone and the common keyword is not included in the software name of the software and the software name of the detection candidate software, the detection unit 134 excludes the detection candidate software from the candidates for the dependence relationship. In this case, the detection unit 134 determines that the detection candidate software has a dependence relationship with other software, and excludes the detection candidate software from the candidates having a dependence relationship with the software.

[Effects] The server (detection device) 10 according to the present embodiment includes the division unit 131 that divides a source code of software into a plurality of code blocks, the calculation unit 132 that calculates a hash value of each of the plurality of code blocks after division in the division unit 131, the generation unit 133 that generates a database in which the hash value of each of the plurality of code blocks calculated by the calculation unit 132 is associated with a value based on the hash value, and the detection unit 134 that detects information regarding detection target software having a dependence relationship with the software on the basis of the database generated by the generation unit 133.

Here, in the related art, since only software having a code block of a hash value matching a hash value of each of a plurality of code blocks is detected as detection target software, in some cases, detection omission cannot be reduced. On the other hand, on the basis of the database in which the hash value of each of the plurality of code blocks and the value based on the hash value are associated with each other, the server 10 also detects software having a code block having a value similar to the hash value of each of the plurality of code blocks as detection target software in addition to the software. As a result, the server 10 can reduce detection omission of detection target software.

In the related art, the hash value of each of the plurality of code blocks of the software is compared with the hash value of each of the plurality of code blocks of the detection candidate software in a round-robin. In contrast, the server 10 can search for a value similar to the hash value of each of the plurality of code blocks at a high speed by using the database. As a result, the server 10 can greatly reduce the number of Hamming distance calculation processes and pieces of detection candidate software, and can efficiently search for a value similar to the hash value of the code block of the index software.

That is, the server 10 can search for a code block similar to the code block of the index software. As a result, the server 10 can efficiently search for detection target software having a code block similar to a code block of a source code. As described above, the server 10 can reduce the time required for searching for detection target software in addition to reducing the detection omission of the detection target software.

In the server 10 according to the present embodiment, the generation unit 133 generates a database in which the hash value of each of the plurality of code blocks is associated with each value configured by a combination of parts of a code string represented as the hash value. As a result, the server 10 can efficiently generate a database including a value similar to the hash value.

In the server 10 according to the present embodiment, the detection unit 134 may detect information regarding detection target software further on the basis of a Hamming distance between the hash value of each of the plurality of code blocks and each value configured by a combination of parts of a code string represented as the hash value. As a result, the server 10 can detect information regarding detection target software including a code block having a value similar to the hash value of each of the plurality of code blocks.

In the server 10 according to the present embodiment, in a case where a common keyword is not included in the path of the code clone that matches between the software and the detection candidate software, the detection unit 134 detects the detection candidate software as detection target software. For example, in a case where a common keyword is included in the path of the code clone, the server 10 determines that code clones included in the index software and the detection candidate software match each other, and there is no dependence relationship between these pieces of software. The server 10 determines that the detection candidate software has a dependence relationship with software different from the index software, and excludes the detection candidate software from candidates for a dependence relationship. In a case where the common keyword is not included in the path of the code clone, the server 10 determines that the code clones included in the index software and the detection candidate software do not match, and there is a dependence relationship between these pieces of software. The server 10 detects the detection candidate software as detection target software.

As a result, the server 10 can reduce erroneous detection that the index software and the detection candidate software have an implicit dependence relationship with each other even if the index software and the detection candidate software include the code clones. The server 10 can reduce detection omission and erroneous detection by using two algorithms: an algorithm for detecting information regarding detection target software having a dependence relationship with software on the basis of a database in which a hash value of each of a plurality of code blocks and a value based on the hash value are associated with each other; and an algorithm for detecting detection candidate software as detection target software in a case where a common keyword is not included in a path of a code clone.

In the server 10 according to the present embodiment, in a case where a common keyword is not included in a directory name or a file name of the code clone, the detection unit 134 detects the detection candidate software as detection target software. That is, when the common keyword is not included in the directory name or the file name of the code clone in the path of the code clone, the server 10 detects the detection candidate software as the detection target software. As a result, the server 10 can further reduce erroneous detection of detection target software.

In the server 10 according to the present embodiment, in a case where the common keyword is included in the path of the code clone and the common keyword is not included in the software name of the software and the software name of the detection candidate software, the detection unit 134 excludes the detection candidate software from the candidates for the dependence relationship. That is, the server 10 performs two-stage determination including determination as to whether the common keyword is included in the path of the code clone and determination as to whether the common keyword is included in the software name of the software and the software name of the detection candidate software. In this case, for example, the server 10 determines that the detection candidate software has a dependence relationship with other software, and excludes the detection candidate software from candidates having a dependence relationship with the software. As a result, the server 10 can further reduce erroneous detection of detection target software.

[Program] It is also possible to create a program in which the processing executed by the server 10 according to the above-described embodiment is described in a language executable by a computer. In this case, by the computer executing the program, the same effects as those of the above-described embodiment can be achieved. Further, the program may be recorded in a computer-readable recording medium, and the program recorded in the recording medium may be read and executed by a computer to implement processing similar to the above-described embodiment.

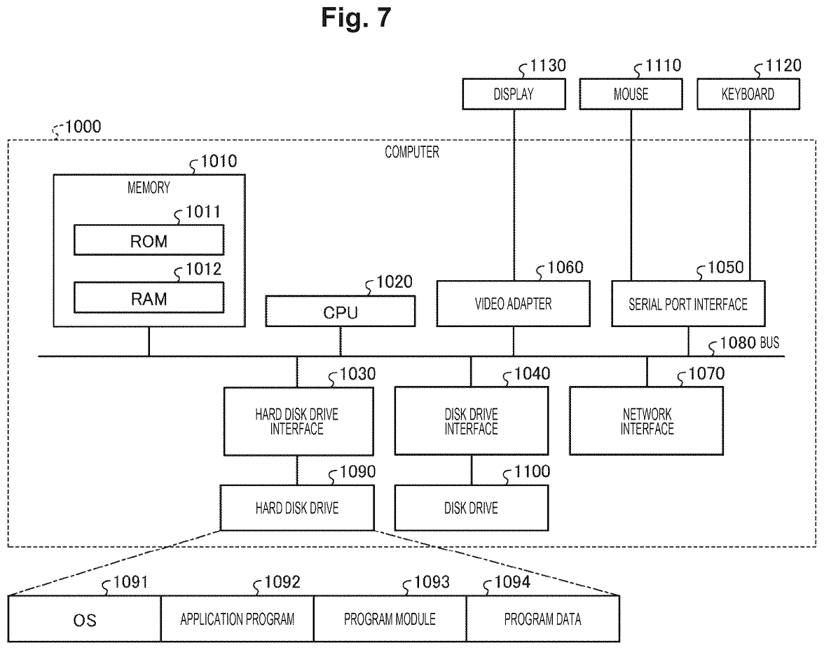

FIG. 7 is a diagram illustrating an example of a computer that executes the detection program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a RAM1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program that defines each process of the server 10 is realized as the program module 1093 in which a code executable by a computer is described. The program module 1093 is stored in, for example, the hard disk drive 1090. For example, the program module 1093 for executing processing similar to the functional configuration of the server 10 is stored in the hard disk drive 1090. The hard disk drive 1090 may be replaced with an SSD.

Setting data used in the processing of the above-described embodiment is stored in, for example, the memory 1010 or the hard disk drive 1090 as the program data 1094. The CPU 1020 reads the program module 1093 and the program data 1094 stored in the memory 1010 and the hard disk drive 1090 to the RAM1012 as necessary, and executes the processing of the above-described embodiment.

The program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (a LAN, a wide area network (WAN), or the like). The program module 1093 and the program data 1094 may be read by the CPU 1020 from another computer via the network interface 1070.

### Reference Signs List

1 Detection system
10 Server (detection device)
11, 23 Communication unit
12 Input reception unit
13, 22 Control unit
14 Output unit
15, 24 Storage unit
20 Client
21 Input unit
131 Division unit
132 Calculation unit
133 Generation unit
134 Detection unit
1311 Indexing unit
1312 Code division unit
DB1 Distance index database
DB2 Software database

1. A detection device comprising:
a memory; and
processing circuitry configured to:
divide a source code of software into a plurality of code blocks;
calculate a hash value of each of the plurality of code blocks after division;
generate a database in which the hash value of each of the plurality of code blocks calculated is associated with a value based on the hash value; and
detect information regarding detection target software having a dependence relationship with the software on a basis of the database generated.

2. The detection device according to claim 1, wherein the processing circuitry is further configured to generate the database in which the hash value of each of the plurality of code blocks is associated with each value configured by a combination of parts of a code string represented as the hash value.

3. The detection device according to claim 2, wherein the processing circuitry is further configured to detect the information regarding the detection target software further on the basis of a Hamming distance between the hash value of each of the plurality of code blocks and each value configured by the combination of the parts of the code string represented as the hash value.

4. The detection device according to claim 1, wherein, in a case where a common keyword is not included in a path of a code clone that matches between the software and detection candidate software, the processing circuitry is further configured to detect the detection candidate software as the detection target software.

5. The detection device according to claim 4, wherein, in a case where the common keyword is not included in a directory name or a file name of the code clone, the processing circuitry is further configured to detect the detection candidate software as the detection target software.

6. The detection device according to claim 4, wherein, in a case where the common keyword is included in the path of the code clone and the common keyword is not included in a software name of the software and a software name of the detection candidate software, the processing circuitry is further configured to exclude the detection candidate software from candidates for the dependence relationship.

7. A detection method executed by a detection device, comprising:
dividing a source code of software into a plurality of code blocks;
calculating a hash value of each of the plurality of code blocks after division;
generating a database in which the hash value of each of the plurality of code blocks calculated step is associated with a value based on the hash value; and
detecting information regarding detection target software having a dependence relationship with the software on a basis of the database generated.

8. A non-transitory computer-readable recording medium storing therein a detection program that causes a computer to execute a process comprising:
dividing a source code of software into a plurality of code blocks;
calculating a hash value of each of the plurality of code blocks after division;
generating a database in which the hash value of each of the plurality of code blocks calculated is associated with a value based on the hash value; and
detecting information regarding detection target software having a dependence relationship with the software on a basis of the database generated.
